(19) United States
(12) Patent Application Publication
(10) Pub. No.: US 2007/0238637 A1
(43) Pub. Date: Oct. 11, 2007

(54) Method for Producing Granulated or Powdery Detergent Compounds

(75) Inventors: Kathrin Michl, Ludwigshafen (DE); Tanja Seebeck, Bensheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/629,696

(22) PCT Filed: Jun. 18, 2005
(86) PCT No.: PCT/EP05/06597

§ 371 Date: Dec. 15, 2006

(30) Foreign Application Priority Data
Jun. 25, 2004 (DE) 10 2004 031 040.8

(51) Int. Cl. C11D 3/37

(52) U.S. Cl. 510/476

(57) ABSTRACT

The present invention relates to a process for preparing granular or pulverulent detergent compositions, comprising the preparation of a detergent base powder by drying an aqueous detergent slurry, which comprises adding to the slurry a copolymer which is obtainable by free-radical copolymerization of (A) from 50 to 99.5 mol % of a monoethylenically unsaturated monocarboxylic acid and/or a salt thereof,
(B) from 0.5 to 20 mol % of an alkoxylated monoethylenically unsaturated monomer I 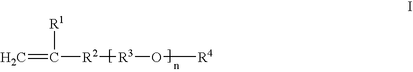 in which the variables are defined as follows:
R¹ is hydrogen or methyl;
R² is —(CH₂)ₓ—O—, —CH₂—NR⁵—, —CH₂—O—CH₂—CR⁶R⁷—CH₂—O— or —CONH—;
R³ are each identical or different C₂-C₄-alkylene radicals which may be arranged blockwise or randomly, the proportion of ethylene radicals being at least 50 mol %;
R⁴ is hydrogen, C₁-C₄-alkyl, —SO₃M or —PO₃M₂;
R⁵ is hydrogen or —CH₂—CR¹═CH₂;
R⁶ is —O—[R³—O]ₙ—R⁴, where the —[R³—O]ₙ— radicals may be different from the further —[R³—O]ₙ— radicals present in formula I;
R⁷ is hydrogen or ethyl; M is alkali metal or hydrogen; n is from 4 to 250; x is 0 or 1, (C) from 0 to 50 mol % of a monoethylenically unsaturated dicarboxyic acid, of an anhydride and/or of a salt thereof and (D) from 0 to 20 mol % of a further copolymerizable monoethylenically unsaturated monomer
   and has an average molecular weight M_{w} of from 30 000 to 500 000 g/mol and a K value of from 40 to 150 (measured at pH 7 in 1% by weight aqueous solution at 25° C.).

The present invention relates to a process for preparing granular or pulverulent detergent compositions, comprising the preparation of a detergent base powder by drying an aqueous detergent slurry, and also to detergent compositions comprising a copolymer which is obtainable by free-radical copolymerization of
(A) from 50 to 99.5 mol % of a monoethylenically unsaturated monocarboxylic acid and/or a salt thereof,
(B) from 0.5 to 20 mol % of an alkoxylated monoethylenically unsaturated monomer of the formula I 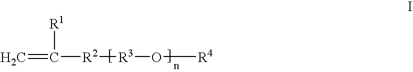
   in which the variables, are defined as follows:
   R¹ is hydrogen or methyl;
   R² is —(CH₂)ₓ—O—, —CH₂—NR⁵—, —CH₂—O—CH₂—CR⁶R⁷—CH₂—O— or —CONH—;
   R³ are each identical or different C₂-C₄-alkylene radicals which may be arranged blockwise or randomly, the proportion of ethylene radicals being at least 50 mol %;
   R⁴ is hydrogen, C₁-C₄-alkyl, —SO₃M or —PO₃M₂;
   R⁵ is hydrogen or —CH₂—CR¹═CH₂;
   R⁶ is —O—[R³—O]ₙ—R⁴, where the —[R³—O]ₙ— radicals may be different from the further —[R³—O]ₙ— radicals present in formula I;
   R⁷ is hydrogen or ethyl;
   M is alkali metal or hydrogen;
   n is from 4 to 250;
   x is 0 or 1,
(C) from 0 to 50 mol % of a monoethylenically unsaturated dicarboxyic acid, of an anhydride and/or of a salt thereof
and
(D) from 0 to 20 mol % of a further copolymerizable monoethylenically unsaturated monomer
   and has an average molecular weight M_{w} of from 30 000 to 500 000 g/mol and a K value of from 40 to 150 (measured at pH 7 in 1% by weight aqueous solution at 25° C.),
   and to the use of this copolymer as an additive in detergent compositions.

In the preparation of powder detergents or base powders for further processing to solid detergents (for example extrusion with addition of further components to give granules), up to 30 liquid or solid components, some in very different amounts, have to be homogenized very intensively and uniformly, which is effected by slurrying in water. In this slurrying, various components, for example surfactants and the zeolites used as builders, result in highly viscous mixtures. Since very highly concentrated slurries are desired for the subsequent spray drying, it is necessary to use assistants which lower the viscosity of the slurries.

In U.S. Pat. Nos. 5,595,968, 5,618,782 and 5,733,861, copolymers of acrylic acid and ethoxylated allyl ethers having an average molecular weight M_{w} of about 12 000 are used for this purpose.

EP-A-778 340 describes the use of these copolymers and of copolymers of acrylic acid and either propoxylated or ethoxylated allyl ethers as film inhibitors in machine dishwashing compositions.

Finally, according to WO-A-91/09932, it is also possible for this purpose to use copolymers based on unsaturated mono- and/or dicarboxylic acids with a hydrophilic basic skeleton and hydrophobic side chains. The side chains are bonded to the basic skeleton via ester, ether or amide functions and may consist of polyalkylene oxides which either have a high proportion of C₃-C₄-alkylene oxides or are end group-capped by long-chain alkyl radicals.

It is an object of the invention to enable, in an advantageous manner, the preparation of solid detergent compositions by using viscosity-lowering polymers. In addition, the polymers used should have advantageous performance in the detergents obtained.

Accordingly, a process has been found for preparing granular or pulverulent detergent compositions, comprising the preparation of a detergent base powder by drying an aqueous detergent slurry, which comprises adding to the slurry a copolymer which is obtainable by free-radical copolymerization of
(A) from 50 to 99.5 mol % of a monoethylenically unsaturated monocarboxylic acid and/or a salt thereof,
(B) from 0.5 to 20 mol % of an alkoxylated monoethylenically unsaturated monomer of the formula I 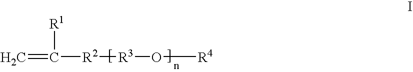
   in which the variables are defined as follows:
   R¹ is hydrogen or methyl;
   R² is —(CH₂)ₓ—, —CH₂—NR⁵—, —CH₂—O—CH₂—CR⁶R⁷—CH₂O— or —CONH—;
   R³ are each identical or different C₂-C₄-alkylene radicals which may be arranged blockwise or randomly, the proportion of ethylene radicals being at least 50 mol %;
   R⁴ is hydrogen, C₁-C₄-alkyl, —SO₃M or —PO₃M₂;
   R⁵ is hydrogen or —CH₂—CR¹═CH₂;
   R⁶ is —O—[R³—O]ₙ—R⁴, where the —[R³—O]ₙ— radicals may be different from the further —[R³—O—]ₙ— radicals present in formula I;
   R⁷ is hydrogen or ethyl;
   M is alkali metal or hydrogen;
   n is from 4 to 250;
   x is 0 or 1,
(C) from 0 to 50 mol % of a monoethylenically unsaturated dicarboxyic acid, of an anhydride and/or of a salt thereof
and
(D) from 0 to 20 mol % of a further copolymerizable monoethylenically unsaturated monomer
   and has an average molecular weight M_{w} of from 30 000 to 500 000 g/mol and a K value of from 40 to 150 (measured at pH 7 in 1% by weight aqueous solution at 25° C.).

Moreover, a process has been found for reducing the viscosity of detergent slurries, which comprises adding to the slurry these copolymers.

Furthermore, detergent slurries and detergent compositions have been found which comprise these copolymers.

Finally, the use of these copolymers as an additive in detergent compositions has been found.

The copolymers used in accordance with the invention comprise, as the copolymerized monomer (A), a monoethylenically unsaturated monocarboxylic acid, preferably a C₃-C₆-monocarboxylic acid, and/or a water-soluble salt, especially an alkali metal salt, such as potassium and in particular sodium salt, or ammonium salt, of this acid.

Specific examples of suitable monomers (A) are: acrylic acid, methacrylic acid, crotonic acid and vinylacetic acid. It is of course also possible to use mixtures of these acids.

A particularly preferred monomer (A) is acrylic acid.

The copolymers used in accordance with the invention comprise from 50 to 99.5 mol % of the monomer (A). When the copolymers are composed only of the monomers (A) and (B), the content of the monomer (A) is generally from 80 to 99.5 mol %, preferably from 90 to 98 mol %. Terpolymers of the monomers (A), (B) and (C) comprise generally from 60 to 98 mol %, preferably from 70 to 95 mol %, of the monomer (A).

As the copolymerized monomer (B), the copolymers used in accordance with the invention comprise an alkoxylated monoethylenically unsaturated monomer of the formula I 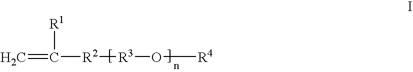
in which the variables are defined as follows:
R¹ is hydrogen or methyl, preferably hydrogen;
R² is —(CH₂)ₓ—O—, —CH₂NR⁵—, —CH₂—O—CH₂—CR⁶R⁷—CH₂—O— or —CONH—, preferably —(CH₂)ₓ—O—, —CH₂—NR⁵— or —CH₂—O—CH₂—CR⁶R⁷—CH₂—O— and more preferably —(CH₂)ₓ—O— or —CH₂—O—CH₂—CR⁶R⁷—CH—O—;
R³ are each identical or different C₂-C₄-alkylene radicals which may be arranged blockwise or randomly, the proportion of ethylene radicals being at least 50 mol %, preferably at least 75 mol % and more preferably 100 mol %;
R⁴ is hydrogen, C₁-C₄-alkyl, —SO₃M or —PO₃M₂;
R⁵ is hydrogen or —CH₂—CR¹═CH₂;
R⁶ is —O—[R³—O]ₙ—R⁴, where the —[R³—O]ₙ— radicals may be different from the further —[R³]ₙ— radicals present in formula I and the preferences specified for R³ apply;
R⁷ is hydrogen or ethyl;
M is alkali metal, preferably sodium or potassium, or hydrogen;
n is from 4 to 250, preferably from 5 to 200 and more preferably from 10 to 100;
x is 0 or 1.

Specific examples of particularly suitable monomers (B) are the alkoxylation products of the following unsaturated monomers: (meth)allyl alcohol, (meth)allylamines, diallylamines, glycerol monoallyl ether, trimethylolpropane monoallyl ether, vinyl ethers, vinylamides and vinylamines.

It is of course also possible to use mixtures of the monomers (B).

Particularly preferred monomers (B) are based on allyl alcohol, glycerol monoallyl ether, trimethylolpropane monoallyl ether and diallylamine.

Very particularly preferred monomers (B) are ethoxylated allyl alcohols which comprise especially from 5 to 20, in particular from 10 to 100 mol of EO/mol.

The monomers (B) may be prepared by commonly known standard organic chemistry processes, for example by amidation and transamidation of suitable (meth)acrylic acids, by alkoxylation of allyl alcohol, glycerol monoallyl ether or trimethylolpropane monoallyl ether, by etherification of allyl halides with poly-C₂-C₄-alkylene oxides and by vinylation of polyalkylene oxides having OH or NH end group with acetylene.

When the copolymers used in accordance with the invention are to have —SO₃M or —PO₃M₂ end groups, they may be introduced by sulfation or phosphation of the monomers (B) or else of the copolymers themselves, for example with chlorosulfonic acid and polyphosphoric acid respectively.

The copolymers used in accordance with the invention comprise from 0.5 to 20 mol % of the monomer (B). When the copolymers are composed only of the monomers (A) and (B), the content of the monomer (B) is generally from 0.5 to 20 mol %, preferably from 1 to 10 mol %. Terpolymers of the monomers (A), (B) and (C) comprise generally from 1 to 15 mol %, preferably from 1 to 10 mol %, of the monomer (B).

The copolymers used in accordance with the invention may comprise, as the copolymerized monomer (C), a monoethylenically unsaturated dicarboxylic acid, preferably a C₄-C₈-dicarboxylic acid. It is of course also possible to use, instead of the free acid, its anhydride and/or one of its water-soluble salts, in particular an alkali metal salt such as potassium and in particular sodium salt, or ammonium salt.

Specific examples of suitable monomers (C) are: maleic acid, fumaric acid, methylenemalonic acid, citraconic acid and itaconic acid. It is of course also possible to use mixtures of these acids.

A particularly preferred monomer (C) is maleic acid.

When the monomer (C) is present in the copolymers used in accordance with the invention, its content is generally from 1 to 30 mol %, preferably from 5 to 30 mol %.

The copolymers used in accordance with the invention are preferably composed only of the monomers (A) and (B) or of the monomers (A), (B) and (C).

However, they may also comprise a further monoethylenically unsaturated monomer (D) which is different from the monomers (A) to (C) but is copolymerizable with these monomers.

Examples of suitable monomers (D) are
esters of monoethylenically unsaturated C₃-C₅-carboxylic acids, in particular (meth)acrylic esters, such as methyl, ethyl, propyl, hydroxypropyl, n-butyl, isobutyl, 2-ethylhexyl, decyl, lauryl, isobornyl, cetyl, palmityl and stearyl (meth)acrylate;
(meth)acrylamides such as (meth)acrylamide, N—(C₁-C₁₂-alkyl)- and N,N-di(C₁-C₄-alkyl)(meth)acrylamides such as N-methyl-, N,N-dimethyl-, N-ethyl-, N-propyl-, N-tert-butyl-, N-tert-octyl- and N-undecyl(meth)acrylamide;
vinyl esters of C₂-C₃₀-, in particular C₂-C₁₄-carboxylic acids, such as vinyl acetate, vinyl propionate, vinyl butyrate, vinyl 2-ethylhexanoate and vinyl laurate;
N-vinylamides and N-vinyllactams, such as N-vinylformamide, N-vinyl-N-methylformamide, N-vinylacetamide, N-vinyl-N-methylacetamide, N-vinylpyrrolidone, N-vinylpiperidone and N-vinylcaprolactam;
vinylsulfonic acid and vinylphosphonic acid;
styrenics such as styrene and substituted styrenes, for example alkylstyrenes such as methylstyrene and ethylstyrene.

When monomers (D) are present in the copolymers used in accordance with the invention, their content is generally from 1 to 20 mol %, preferably from 1 to 10 mol %. When hydrophobic monomers are used as the monomer (D), their content should be selected such that the copolymer retains its hydrophilic character overall.

The copolymers used in accordance with the invention have an average molecular weight M_{w} of from 30 000 to 500 000 g/mol, preferably from 50 000 to 300 000 g/mol (determined by gel permeation chromatography at room temperature with aqueous eluent).

Their K values are correspondingly from 40 to 150, preferably from 50 to 125 (measured at pH 7 in 1% by weight aqueous solution at 25° C.; according to H. Fikentscher, Cellulose-Chemie, vol. 13, p. 58-64 and 71-74 (1932)).

The copolymers used in accordance with the invention may be obtained by the known free-radical polymerization processes. In addition to polymerization in bulk, particular mention should be made of solution and emulsion polymerization, preference being given to solution polymerization.

The polymerization is preferably carried out in water as a solvent. However, it may also be undertaken in alcoholic solvents, especially in C₁-C₄-alcohols, such as methanol, ethanol and isopropanol, or in mixtures of these solvents with water.

Suitable polymerization initiators are compounds which decompose to form radicals either thermally or photochemically (photoinitiators).

Among the thermally activable polymerization initiators, preference is given to initiators having a decomposition temperature in the range from 20 to 180° C., in particular from 50 to 120° C. Examples of suitable thermal initiators are inorganic peroxo compounds, such as peroxodisulfates (ammonium and preferably sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroyl peroxide, dibenzoyl peroxide, bis(o-toloyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azo compounds such as 2,2′-azobisisobutyronitrile, 2,2′-azobis(2-methylbutyronitrile) and azobis-(2-amidopropane) dihydrochloride.

These initiators may be used in combination with reducing compounds as initiator/regulator systems. Examples of such reducing compounds are phosphorous compounds such as phosphorous acid, hypophosphites and phosphinates, and sulfur compounds such as sodium hydrogensulfite, sodium sulfite and sodium formaldehyde sulfoxylate.

In combination with the initiators or the redox initiator systems, it is additionally possible to use transition metal catalysts, for example salts of iron, cobalt, nickel, copper, vanadium and manganese. Suitable salts are, for example, iron(II) sulfate, cobalt(II) chloride, nickel(II) sulfate, copper(I) chloride. The reducing transition metal salt is used typically in an amount of from 0.1 to 1000 ppm, based on the sum of the monomers. Examples of particularly advantageous combinations are those of hydrogen peroxide and iron(II) salts, such as a combination of from 0.5 to 30% by weight of hydrogen peroxide and from 0.1 to 500 ppm of FeSO₄.7H₂O, based in each case on the sum of the monomers.

Examples of suitable photoinitiators are benzophenone, acetophenone, benzoin ether, benzyldialkyl ketones and derivatives thereof.

Preference is given to using thermal initiators, of which inorganic peroxo compounds, especially hydrogen peroxide and in particular sodium peroxodisulfate (sodium persulfate) are preferred.

Advantageously, the peroxo compounds are used in combination with sulfur-containing reducing agents, sodium hydrogensulfite, as redox initiator systems. When this initiator/regulator system is used, copolymers are obtained which comprise —SO₃⁻ Na⁺ and/or —SO₄⁻ Na⁺ end groups.

Alternatively, it is also possible to use phosphorus-containing initiator/regulator systems, for example hypophosphites/phosphinates.

The amounts of photoinitiator or initiator/regulator system have to be matched to the particular monomers used. When, for example, the preferred peroxodisulfate/hydrogensulfite system is used, typically from 2 to 6% by weight, preferably from 3 to 5% by weight, of peroxodisulfate, and generally from 5 to 30% by weight, preferably from 5 to 10% by weight, of hydrogensulfite are used, based in each case on the sum of the monomers.

If desired, polymerization regulators may also be used. Suitable compounds are those known to those skilled in the art, for example sulfur compounds such as mercaptoethanol, 2-ethylhexyl thioglycolate, thioglycolic acid and dodecyl mercaptan.

When polymerization regulators are used, their use amount is generally from 0.1 to 15% by weight, preferably from 0.1 to 5% by weight and more preferably from 0.1 to 2.5% by weight, based on the sum of the monomers.

The polymerization temperature is generally from 30 to 200° C., preferably from 50 to 150° C. and more preferably from 80 to 130° C.

The polymerization is preferably undertaken under protective gas such as nitrogen or argon and may be carried out under atmospheric pressure, but it is preferably undertaken in closed systems under the autogenous pressure which develops.

The copolymers used in accordance with the invention are typically obtained in the form of a polymer solution which has a solids content of from 10 to 70% by weight, preferably from 25 to 60% by weight.

It is possible using the copolymers used in accordance with the invention to effectively lower the viscosity of aqueous detergent slurries, especially of the slurries which are dried to prepare granular or pulverulent detergent compositions, so that even highly concentrated slurries can be handled without any problem. For instance, the slurry concentrations may always be ≧50% by weight, preferably ≧60% by weight and more preferably ≧65% by weight, based on the anhydrous detergent components.

The inventive copolymers additionally bring about stabilization and homogenization of the slurries and prevent separations.

They are added to the slurries generally in amounts of from 0.01 to 10% by weight, preferably from 0.05 to 5% by weight and more preferably from 0.1 to 5% by weight, based on the overall mixture.

They may either be added to the overall mixture or added in any portions to individual detergent components, for example the surfactants or the builder premixes, whose solids contents may also already have been raised in this way.

The copolymers used in accordance with the invention are not only outstandingly suitable as processing assistants for detergent production owing to their viscosity-lowering and stabilizing action, but also feature advantageous performance properties in the washing operation itself which could not have been foreseen. For instance, they have both an encrustation-inhibiting and graying-inhibiting action in solid and liquid detergent compositions.

Inventive solid detergent formulations which comprise the polymers used in accordance with the invention advantageously have, for example, the following composition:
(a) from 0.01 to 10% by weight of at least one inventive copolymer,
(b) from 0.5 to 40% by weight of at least one nonionic, anionic and/or cationic surfactant,
(c) from 0.5 to 80% by weight of an inorganic builder,
(d) from 0 to 10% by weight of an organic cobuilder and
(e) from 0 to 60% by weight of other customary ingredients, such as standardizers, enzymes, perfume, complexing agents, corrosion inhibitors, bleaches, bleach activators, bleach catalysts, dye transfer inhibitors, further graying inhibitors, soil-release polyesters, fiber and dye protection additives, silicones, dyes, bactericides, dissolution improvers and/or disintegrants,
   the sum of components (a) to (e) being 100% by weight.

Inventive liquid detergent formulations may, for example, have the following composition:
(a) from 0.01 to 10% by weight of at least one inventive copolymer,
(b) from 0.5 to 40% by weight of at least one nonionic, anionic and/or cationic surfactant,
(c) from 0 to 20% by weight of an inorganic builder,
(d) from 0 to 10% by weight of an organic cobuilder,
(e) from 0 to 60% by weight of other customary ingredients, such as sodium carbonate, enzymes, perfume, complexing agents, corrosion inhibitors, bleaches, bleach activators, bleach catalysts, dye transfer inhibitors, further graying inhibitors, soil-release polyesters, fiber and dye protection additives, silicones, dyes, bactericides, organic solvents, solubilizers, hydrotropes, thickeners and/or alkanolamines and
(f) from 0 to 99.45% by weight of water.

Suitable nonionic surfactants (b) are in particular:
alkoxylated C₈-C₂₂-alcohols, such as fatty alcohol alkoxylates, oxo alcohol alkoxylates and Guerbet alcohol ethoxylates: the alkoxylation may be effected with ethylene oxide, propylene oxide and/or butylene oxide. Block copolymers or random copolymers may be present. Per mole of alcohol, they typically comprise from 2 to 50 mol, preferably from 3 to 20 mol, of at least one alkylene oxide. A preferred alkylene oxide is ethylene oxide. The alcohols preferably have from 10 to 18 carbon atoms.
alkylphenol alkoxylates, in particular alkylphenol ethoxylates, which comprise C₆-C₁₄-alkyl chains and from 5 to 30 mol of alkylene oxide/mole.
alkyl polyglucosides which comprise C₈-C₂₂-, preferably C₁₀-C₁₈-alkyl chains and generally from 1 to 20, preferably from 1.1 to 5, glucoside units.
N-alkylglucamides, fatty acid amide alkoxylates, fatty acid alkanolamide alkoxylates, and block copolymers of ethylene oxide, propylene oxide and/or butylene oxide.

Suitable anionic surfactants are, for example:
sulfates of (fatty) alcohols having from 8 to 22, preferably from 10 to 18, carbon atoms, in particular C₉C₁₁-alcohol sulfates, C₁₂C₁₄-alcohol sulfates, C₁₂-C₁₈-alcohol sulfates, lauryl sulfate, cetyl sulfate, myristyl sulfate, palmityl sulfate, stearyl sulfate and tallow fatty alcohol sulfate.
sulfated alkoxylated C₈-C₂₂-alcohols (alkyl ether sulfates): compounds of this type are prepared, for example, by first alkoxylating a C₈-C₂₂-, preferably a C₁₀-C₁₈-alcohol, for example a fatty alcohol, and then sulfating the alkoxylation product. For the alkoxylation, preference is given to using ethylene oxide.
linear C₈-C₂₀-alkylbenzenesulfonates (LAS), preferably linear C₉-C₁₃-alkylbenzene-sulfonates and -alkyltoluenesulfonates.
alkanesulfonates, in particular C₈-C₂₄-, preferably C₁₀-C₁₈-alkanesulfonates.
soaps, such as the sodium and potassium salts of C₈-C₂₄-carboxylic acids.

The anionic surfactants are added to the detergent preferably in the form of salts. Suitable salts are, for example, alkali metal salts such as sodium, potassium and lithium salts, and ammonium salts such as hydroxyethylammonium, di(hydroxyethyl)-ammonium and tri(hydroxyethyl)ammonium salts.

Particularly suitable cationic surfactants include:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines which have been esterified with C₈-C₂₂-carboxylic acids;
imidazoline quats, in particular 1-alkylimidazolinium salts of the formulae II or III 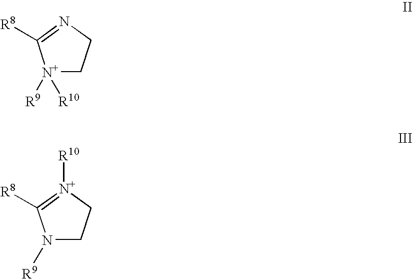
in which the variables are defined as follows:
R⁸ is C₁-C₂₅-alkyl or C₂-C₂₅-alkenyl;
R⁹ is C₁-C₄-alkyl or hydroxy-C₁-C₄-alkyl;
R¹⁰ is C₁-C₄-alkyl, hydroxy-C₁-C₄-alkyl or an R⁸—(CO)—X—(CH₂)ₚ— radical (X: —O— or —NH—; p: 2 or 3),
where at least one R⁸ radical is C₇-C₂₂-alkyl.

Suitable inorganic builders are in particular:
crystalline and amorphous alumosilicates having ion-exchanging properties, in particular zeolites: various types of zeolites are suitable, especially the zeolites A, X, B, P, MAP and HS in their Na form or in forms in which Na has been partly exchanged for other cations such as Li, K, Ca, Mg or ammonium.
crystalline silicates, especially disilicates and sheet silicates, for example δ- and β-Na₂Si₂O₅. The silicates may be used in the form of their alkali metal, alkaline earth metal or ammonium salts; preference is given to the sodium, lithium and magnesium silicates.
amorphous silicates, such as sodium metasilicate and amorphous disilicate.
carbonates and hydrogencarbonates: these may be used in the form of their alkali metal, alkaline earth metal or ammonium salts. Preference is given to sodium, lithium and magnesium carbonates and hydrogencarbonates, especially sodium carbonate and/or sodium hydrogencarbonate.
polyphosphates, such as pentasodium triphosphate.

Suitable organic cobuilders are in particular:
low molecular weight carboxylic acids such as citric acid, hydrophobically modified citric acid, e.g. agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, e.g. nitrilotriacetic acid, β-alaninediacetic acid, ethylenediaminetetraacetic acid, serinediacetic acid, isoserinediacetic acid, N-(2-hydroxyethyl)iminodiacetic acid, ethylenediaminedisuccinic acid and methyl- and ethylglycinediacetic acid.
oligomeric and polymeric carboxylic acids such as homopolymers of acrylic acid and aspartic acid, oligomaleic acids, copolymers of maleic acid with acrylic acid, methacrylic acid or C₂-C₂₂-olefins, e.g. isobutene or long-chain α-olefins, vinyl C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid. The oligomeric and polymeric carboxylic acids are used in acid form or as the sodium salt.

Suitable bleaches are, for example, adducts of hydrogen peroxide to inorganic salts, such as sodium perborate monohydrate, sodium perborate tetrahydrate and sodium carbonate perhydrate, and percarboxylic acids such as phthalimidopercaproic acid.

Suitable bleach activators are, for example, N,N,N′,N′-tetraacetylethylenediamine (TAED), sodium p-nonanoyloxybenzenesulfonate and N-methylmorpholinium acetonitrile methylsulfate.

Enzymes used with preference in detergents are proteases, lipases, amylases, cellulases, oxidases and peroxidases.

Suitable dye transfer inhibitors are, for example, homopolymers, copolymers and graft polymers of 1-vinylpyrrolidone, 1-vinylimidazole and 4-vinylpyridine N-oxide. Homopolymers and copolymers of 4-vinylpyridine reacted with chloroacetic acid are also suitable as dye transfer inhibitors.

Detergent ingredients are otherwise generally known. Detailed descriptions can be found, for example, in WO-A-99/06524 and 99/04313; in Liquid Detergents, editor: Kuo-Yann Lai, Surfactant Sci. Ser., Vol. 67, Marcel Dekker, New York, 1997, p. 272-304.

### EXAMPLES

I) Preparation of Inventive Copolymers

To prepare the following copolymers, the monomer (B) used was one of the following

monomers in the form of solutions in distilled water:

monomer (B1): ethoxylated allyl alcohol (16.6 mol of EO/mol)

monomer (B2): sulfated ethoxylated glycerol monoallyl ether (20 mol of EO/mol)

monomer (B3): phosphated ethoxylated glycerol monoallyl ether (20 mol of EO/mol)

monomer (B4): ethoxylated glycerol monoallyl ether (20 mol of EO/mol)

monomer (B5): ethoxylated trimethylolpropane monoallyl ether (15 mol of EO/mol)

monomer (B6): ethoxylated allyl alcohol (10 mol of EO/mol)

### Example 1

In a pressure reactor with stirrer, nitrogen supply, reflux condenser and metering apparatus, 251.8 g of distilled water and 3.40 g of 50% by weight phosphorous acid were heated to internal temperature 95° C. under nitrogen supply and with stirring. Then, continuously in four separate feeds, 595.9 g of acrylic acid (97.7 mol %) within 4 h, 303.0 g of a 50% by weight aqueous solution of monomer (B1) (2.3 mol %) within 4 h, 74.4 g of a 40% by weight aqueous sodium hydrogensulfite solution within 4 h and a mixture of 18.2 g of sodium persulfate and 242.5 g of distilled water within 4.25 h were added. After stirring at 95° C. for a further one hour and cooling to 50° C., 50% by weight sodium hydroxide solution was then used to set a pH of 6.7 within 1.5 h. While maintaining a temperature of from 50 to 60° C., 3.36 g of a 50% by weight aqueous hydrogen peroxide solution were then metered in within 30 min. After stirring at this temperature for a further 30 minutes, dilution was effected with 100 g of distilled water.

A polymer solution having a solids content of 46.2% by weight and a K value of 66.5 (measured at pH 7 in 1% by weight aqueous solution at 25° C.) was obtained.

### Example 2

In a pressure reactor with stirrer, nitrogen supply, reflux condenser and metering apparatus, 135.1 g of distilled water and 2.27 g of 50% by weight phosphorous acid were heated to internal temperature 95° C. under nitrogen supply and with stirring. Then, continuously in four separate feeds, 368.8 g of acrylic acid (97.0 mol %) within 4 h, 150.0 g of a 50% by weight aqueous solution of monomer (B1) (3.0 mol %) within 4 h, 74.1 g of a 40% by weight aqueous sodium hydrogensulfite solution within 4 h and a mixture of 12.1 g of sodium persulfate and 160.1 g of distilled water within 4.25 h were added. After stirring at 95° C. for a further one hour and cooling to 50° C., 50% by weight sodium hydroxide solution was then used to set a pH of 6.9 within 1.5 h. While maintaining a temperature of from 50 to 60° C., 2.14 g of a 50% by weight aqueous hydrogen peroxide solution were then metered in within 30 min and stirred at this temperature for a further 30 min.

A polymer solution having a solids content of 47.8% by weight and a K value of 45.9 (measured at pH 7 in 1% by weight aqueous solution at 25° C.) was obtained.

### Example 3

In a pressure reactor with stirrer, nitrogen supply, reflux condenser and metering apparatus, 536.4 g of distilled water and 2.57 g of 50% by weight phosphorous acid were heated to internal temperature 95° C. under nitrogen supply and with stirring. Then, continuously in four separate feeds, 417.1 g of acrylic acid (97.0 mol %) within 4 h, 282.8 g of a 50% by weight aqueous solution of monomer (B6) (3.0 mol %) within 4 h, 69.8 g of a 40% by weight aqueous sodium hydrogensulfite solution within 4 h and a mixture of 13.6 g of sodium persulfate and 242.5 g of distilled water within 4.25 h were added. After stirring at 95° C. for a further one hour and cooling to 50° C., 50% by weight sodium hydroxide solution was then used to set a pH of 6.8 within 1.5 h. While maintaining a temperature of from 50 to 60° C., 2.42 g of a 50% by weight aqueous hydrogen peroxide solution were then metered in within 30 min. Finally, the mixture was stirred at this temperature for a further 30 min.

A polymer solution having a solids content of 39.6% by weight and a K value of 52.9 (measured at pH 7 in 1% by weight aqueous solution at 25° C.) was obtained.

### Example 4

In a pressure reactor with stirrer, nitrogen supply, reflux condenser and metering apparatus, 242.3 g of distilled water and 3.40 g of 50% by weight phosphorous acid were heated to internal temperature 95° C. under nitrogen supply and with stirring. Then, continuously in four separate feeds, 595.9 g of acrylic acid (97.7 mol %) within 4 h, 303.0 g of a 50% by weight aqueous solution of monomer (B1) (2.3 mol %) within 4 h, 65.4 g of a 40% by weight aqueous sodium hydrogensulfite solution within 4 h and a mixture of 18.2 g of sodium persulfate and 242.5 g of distilled water within 4.25 h were added. After stirring at 95° C. for a further one hour and cooling to 50° C., 50% by weight sodium hydroxide solution was then used to set a pH of 6.7 within 1.5 h. While maintaining a temperature of from 50 to 60° C., 3.36 g of a 50% by weight aqueous hydrogen peroxide solution were then metered in within 30 min. After stirring at this temperature for a further 30 minutes, dilution was effected with 150 g of distilled water.

A polymer solution having a solids content of 43.7% by weight and a K value of 65.9 (measured at pH 7 in 1% by weight aqueous solution at 25° C.) was obtained.

### Example 5

A pressure reactor with stirrer, nitrogen supply, reflux condenser and metering apparatus was initially charged with 161.5 g of distilled water, 4.07 mg of FeSO₄; 7H₂O and 31.0 g of maleic anhydride (7.4 mol %). With simultaneous addition of 43.0 g of a 50% by weight sodium hydroxide solution, the mixture was heated to internal temperature 99° C. under nitrogen supply. Then, continuously in three separate feeds, 278.1 g of acrylic acid (89.6 mol %) within 4 h, 202.0 g of a 50% by weight aqueous solution of monomer (B1) (3.0 mol %) within 4 h and 82.0 g of a 30% by weight aqueous hydrogen peroxide solution within 4.25 h were added. Finally, the mixture was stirred at 99° C. for a further 1 h.

A polymer solution having a solids content of 44.4% by weight, a pH of 3.4 and a K value of 67.9 (measured at pH 7 in 1% by weight aqueous solution at 25° C.) was obtained.

### Example 6

In a pressure reactor with stirrer, nitrogen supply, reflux condenser and metering apparatus, 161.5 g of distilled water and 69.5 g of maleic anhydride (15.0 mol %) were heated to internal temperature 98° C. under nitrogen supply and with stirring. Then, continuously in four separate feeds, 278.1 g of acrylic acid (82.0 mol %) within 4 h, 202.0 g of a 50% by weight aqueous solution of monomer (B1) (3.0 mol %) within 4 h, 44.8 g of a 40% by weight aqueous sodium hydrogensulfite solution within 4 h and a mixture of 10.9 g of sodium persulfate and 161.7 g of distilled water within 4.25 h were added. After stirring at 98° C. for a further one hour and cooling to 50° C., 50% by weight sodium hydroxide solution was then used to set a pH of 6.7 within 1.5 h. While maintaining a temperature of from 50 to 60° C., 2.24 g of a 50% by weight aqueous hydrogen peroxide solution were then metered in within 30 min. After stirring at this temperature for a further 30 minutes, 600 g of distilled water were added.

A polymer solution having a solids content of 28.8% by weight and a K value of 50.3 (measured at pH 7 in 1% by weight aqueous solution at 25° C.) was obtained.

### Example 7

A pressure reactor with stirrer, nitrogen supply, reflux condenser and metering apparatus was initially charged with 242.3 g of distilled water, 7.51 mg of FeSO₄. 7H₂O and 121.0 g of maleic anhydride (15.0 mol %). With simultaneous addition of 168.0 g of 50% by weight sodium hydroxide solution, the mixture was heated to internal temperature 99° C. under nitrogen supply. Then, continuously in three separate feeds, 484.0 g of acrylic acid (82.5 mol %) within 4 h, 303.0 g of a 50% by weight aqueous solution of monomer (B1) (2.5 mol %) within 4 h and 126.0 g of a 30% by weight aqueous hydrogen peroxide solution within 4.25 h were added. After stirring at this temperature for a further 30 minutes, 450 g of distilled water were added.

A polymer solution having a solids content of 39.0% by weight, a pH of 3.6 and a K value of 86.3 (measured at pH 7 in 1% by weight aqueous solution at 25° C.) was obtained.

### Example 8

In a pressure reactor with stirrer, nitrogen supply, reflux condenser and metering apparatus, 161.5 g of distilled water were heated to internal temperature 95° C. under nitrogen supply and with stirring. Then, continuously in four separate feeds, 399.0 g of acrylic acid (97.7 mol %) within 4 h, 202.0 g of a 50% by weight aqueous solution of monomer (B1) (2.3 mol %) within 4 h, 56.0 g of a 40% by weight aqueous sodium hydrogensulfite solution within 4 h and a mixture of 12.2 g of sodium persulfate and 161.7 g of distilled water within 4.25 h were added. After stirring at 95° C. for a further one hour, addition of 200.0 g of distilled water and cooling to 50° C., 50% by weight sodium hydroxide solution was then used at this temperature to set a pH of 6.6 within 1.5 h.

A polymer solution having a solids content of 42.1% by weight and a K value of 63.5 (measured at pH 7 in 1% by weight aqueous solution at 25° C.) was obtained.

### Example 9

In a pressure reactor with stirrer, nitrogen supply, reflux condenser and metering apparatus, 161.5 g of distilled water, 202.0 g of a 50% by weight aqueous solution of monomer (B1) (2.3 mol %) and 2.27 g of 50% by weight phosphorous acid were heated to internal temperature 95° C. under nitrogen supply and with stirring. Then, continuously in three separate feeds, 397.3 g of acrylic acid (97.7 mol %) within 4 h, 43.6 g of a 40% by weight aqueous sodium hydrogensulfite solution within 4 h and a mixture of 12.2 g of sodium persulfate and 161.7 g of distilled water within 4.25 h were added. After stirring at 95° C. for a further one hour, addition of 200.0 g of distilled water and cooling to 50° C., 50% by weight sodium hydroxide solution was then used at this temperature to set a pH of 6.6 within 1.5 h.

A polymer solution having a solids content of 40.2% by weight and a K value of 74.6 (measured at pH 7 in 1% by weight aqueous solution at 25° C.) was obtained.

### Example 10

In a pressure reactor with stirrer, nitrogen supply, reflux condenser and metering apparatus, 161.5 g of distilled water and 202.0 g of a 50% by weight aqueous solution of monomer (B1) (2.3 mol %) were heated to internal temperature 95° C. under nitrogen supply and with stirring. Then, continuously in three separate feeds, 397.3 g of acrylic acid (97.7 mol %) within 4 h, 31.5 g of a 40% by weight aqueous sodium hydrogensulfite solution within 4 h and a mixture of 12.2 g of sodium persulfate and 161.7 g of distilled water within 4.25 h were added. After stirring at 95° C. for a further one hour, addition of 200.0 g of distilled water and cooling to 50° C., 50% by weight sodium hydroxide solution was then used at this temperature to set a pH of 6.7 within 1.5 h.

A polymer solution having a solids content of 35.7% by weight and a K value of 88.2 (measured at pH 7 in 1% by weight aqueous solution at 25° C.) was obtained.

### Example 11

In a pressure reactor with stirrer, nitrogen supply, reflux condenser and metering apparatus, 500.0 g of distilled water, 4.88 mg of FeSO₄.7H₂O and 101.0 g of a 50% by weight aqueous solution of monomer (B1) (2.3 mol) were heated to internal temperature 100° C. under nitrogen supply and with stirring. Then, continuously in two separate feeds, 397.3 g of acrylic acid (97.7 mol %) within 4 h and 149.4 g of a 50% by weight aqueous hydrogen peroxide solution within 4.5 h were added. After stirring at 100° C. for a further one hour and cooling to 50° C., 50% by weight sodium hydroxide solution was then used at this temperature to set a pH of 6.6 within 1.5 h.

A polymer solution having a solids content of 22.6% by weight and a K value of 124.0 (measured at pH 7 in 1% by weight aqueous solution at 25° C.) was obtained.

### Example 12

In a pressure reactor with stirrer, nitrogen supply, reflux condenser and metering apparatus, 161.5 g of distilled water, 202.0 g of a 50% by weight aqueous solution of monomer (B1) (2.3 mol %) and 2.27 g of 50% by weight phosphorous acid were heated to internal temperature 95° C. for a further one hour under nitrogen supply and with stirring. Then, continuously in three separate feeds, 399.0 g of acrylic acid (97.7 mol %) within 4 h, a mixture of 10.0 g of sodium hypophosphite and 40.0 g of distilled water within 4 h and a mixture of 12.2 g of sodium persulfate and 161.7 g of distilled water within 4.25 h were added. After stirring at 95° C. for a further one hour, addition of 200.0 g of distilled water and cooling to 50° C., 50% by weight sodium hydroxide solution was then used at this temperature to set a pH of 6.9 within 1.5 h.

A polymer solution having a solids content of 30.8% by weight and a K value of 95.1 (measured at pH 7 in 1% by weight aqueous solution at 25° C.) was obtained.

### Example 13

In a pressure reactor with stirrer, nitrogen supply, reflux condenser and metering apparatus, 161.5 g of distilled water, 202.0 g of a 50% by weight aqueous solution of monomer (B1) (2.5 mol %) and 20.0 g of maleic anhydride (2.5 mol %) were heated to internal temperature 95° C. under nitrogen supply and with stirring. Then, continuously in three separate feeds, 379.0 g of acrylic acid (82.5 mol %) within 4 h, 44.0 g of a 40% by weight aqueous sodium hydrogensulfite solution within 4 h and a mixture of 12.2 g of sodium persulfate and 161.7 g of distilled water within 4.25 h were added. After stirring at 95° C. for a further one hour, addition of 200.0 g of distilled water and cooling to 50° C., 50% by weight sodium hydroxide solution was then used at this temperature to set a pH of 6.6 within 1.5 h.

A polymer solution having a solids content of 28.3% by weight and a K value of 101.8 (measured at pH 7 in 1% by weight aqueous solution at 25° C.) was obtained.

### Example 14

In a pressure reactor with stirrer, nitrogen supply, reflux condenser and metering apparatus, 161.5 g of distilled water and 31.0 g of maleic anhydride (7.4 mol %) were heated to internal temperature 98° C. under nitrogen supply and with stirring. Then, continuously in four separate feeds, 278.1 g of acrylic acid (89.6 mol %) within 4 h, 202.0 g of a 50% by weight aqueous solution of monomer (B1) (3.0 mol %) within 4 h, 30.0 g of a 40% by weight aqueous sodium hydrogensulfite solution within 4 h and a mixture of 10.0 g of sodium persulfate and 161.6 g of water within 4.5 h were added. After stirring at 98° C. for a further one hour and cooling to 50° C., 50% by weight sodium hydroxide solution was then used at this temperature to set a pH of 6.8 within 1.5 h. While maintaining a temperature of from 50 to 60° C., 2.24 g of a 50% by weight aqueous hydrogen peroxide solution were then metered in within 30 min. Finally, the mixture was stirred at this temperature for a further 30 min.

A polymer solution having a solids content of 37.4% by weight and a K value of 72.9 (measured at pH 7 in 1% by weight aqueous solution at 25° C.) was obtained.

### Example 15

In a pressure reactor with stirrer, nitrogen supply, reflux condenser and metering apparatus, 161.5 g of distilled water, 4.07 mg of FeSO₄.7H₂O and 31.0 g of maleic anhydride (7.4 mol %) were heated to internal temperature 98° C. under nitrogen supply and with stirring. Then, continuously in three separate feeds, 278.1 g of acrylic acid (89.6 mol %) within 4 h, 202.0 g of a 50% by weight aqueous solution of monomer (B1) (3.0 mol %) within 4 h and a mixture of 41.0 g of a 30% by weight aqueous hydrogen peroxide solution and 161.6 g of water were added within 4.25 h. After stirring at 98° C. for a further one hour, 200.0 g of distilled water were added.

A polymer solution having a solids content of 37.6% by weight, a pH of 1.8 and a K value of 108.8 (measured at pH 7 in 1% by weight aqueous solution at 25° C.) was obtained.

### Example 16

In a pressure reactor with stirrer, nitrogen supply, reflux condenser and metering apparatus, 95.0 g of distilled water were heated to internal temperature 99° C. under nitrogen supply and with stirring. Then, continuously in four separate feeds, 144.93 g of acrylic acid (97.8 mol %) within 4 h, a mixture of 55.1 g of monomer (B2) (2.2 mol %) and 30.0 g of distilled water within 4 h, a mixture of 16.4 g of a 40% by weight aqueous sodium hydrogensulfite solution and 15.16 g of distilled water within 4 h and a mixture of 5.74 g of sodium persulfate and 50.0 g of distilled water within 5 h were added. After stirring at 99° C. for a further one hour and cooling to 50° C., 50% by weight sodium hydroxide solution was used at this temperature to set a pH of 6.7. Finally, a further 100.0 g of distilled water were added.

A polymer solution having a solids content of 41.1% by weight and a K value of 60.4 (measured at pH 7 in 1% by weight aqueous solution at 25° C.) was obtained.

### Example 17

In a pressure reactor with stirrer, nitrogen supply, reflux condenser and metering apparatus, 95.0 g of distilled water and 1.10 g of 50% by weight phosphorous acid were heated to internal temperature 99° C. under nitrogen supply and with stirring. Then, continuously in four separate feeds, 146.39 g of acrylic acid (97.8 mol %) within 4 h, a mixture of 53.61 g of the monomer (B3) (2.2 mol %) and 30.0 g of distilled water within 4 h, 49.5 g of a 40% by weight aqueous sodium hydrogensulfite solution within 4 h and a mixture of 5.74 g of sodium persulfate and 45.3 g of distilled water within 5 h were added. After approx. 2.5 h, 100.0 g of distilled water were added. On completion of the sodium persulfate feeding, the mixture was stirred at 99° C. for a further 1 h. After cooling to 50° C., 50% by weight sodium hydroxide solution was used at this temperature to set a pH of 6.5.

A polymer solution having a solids content of 40.8% by weight and a K value of 69.6 (measured at pH 7 in 1% by weight aqueous solution at 25° C.) was obtained.

### Example 18

In a pressure reactor with stirrer, nitrogen supply, reflux condenser and metering apparatus, 240.0 g of distilled water and 120.0 g of the monomer (B4) (2.3 mol %) were heated to internal temperature 95° C. under nitrogen supply and with stirring. Then, continuously in three separate feeds, 380.0 g of acrylic acid (97.8 mol %) within 4 h, a mixture of 22.0 g of sodium hydrogensulfite and 100.0 g of distilled water within 4 h and a mixture of 12.2 g of sodium persulfate and 160.0 g of distilled water within 4.25 h were added. After stirring at 95° C. for a further one hour and cooling to 60° C., 50% by weight sodium hydroxide solution was used at this temperature to set a pH of 6.4. Finally, a further 100.0 g of distilled water were added.

A polymer solution having a solids content of 47.3% by weight and a K value of 61.7 (measured at pH 7 in 1% by weight aqueous solution at 25° C.) was obtained.

### Example 19

In a pressure reactor with stirrer, nitrogen supply, reflux condenser and metering apparatus, 120.0 g of distilled water and 1.35 g of 50% by weight phosphorous acid were heated to internal temperature 95° C. under nitrogen supply and with stirring. Then, continuously in four separate feeds, 198.3 g (97.8 mol %) of acrylic acid within 4 h, a mixture of 51.7 g of the monomer (B5) (2.2 mol %) and 30.0 g of distilled water within 4 h, a mixture of 8.2 g of sodium hydrogensulfite and 50.0 g of distilled water within 4 h and a mixture of 6.1 g of sodium persulfate and 50.0 g of distilled water within 4.25 h were added. After stirring at 95° C. for a further one hour and cooling to 60° C., 50% by weight sodium hydroxide solution was used to set a pH of 6.5.

A polymer solution having a solids content of 46.0% by weight and a K value of 60.0 (measured at pH 7 in 1% by weight aqueous solution at 25° C.) was obtained.

### Comparative Example C1

In a pressure reactor with stirrer, nitrogen supply, reflux condenser and metering apparatus, 150.0 g of distilled water and 2.17 g of 85% by weight phosphoric acid were heated to internal temperature 95° C. under nitrogen supply and with stirring. Then, continuously in four separate feeds, 375.4 g of acrylic acid (99.2 mol %) within 4 h, 63.6 g of a 50% by weight solution of monomer (B1) (0.8 mol %) within 4 h, 66.2 g of a 40% by weight aqueous sodium hydrogensulfite solution within 4 h and a mixture of 11.50 g of sodium persulfate and 152.2 g of distilled water within 4.25 h were added. After stirring at 95° C. for a further one hour and cooling to 50° C., 50% by weight sodium hydroxide solution was then used to set a pH of 6.7 within 1.5 h. While maintaining a temperature of from 50 to 60° C., 2.12 g of a 50% by weight aqueous hydrogen peroxide solution were then metered in within 30 min. Finally, the mixture was stirred at this temperature for 30 min.

A polymer solution having a solids content of 47.3% by weight and a K value of 34.3 (measured at pH 7 in 1% by weight aqueous solution at 25° C.) was obtained.

II) Testing of Inventive Copolymers

IIa) Testing of the Viscosity-Lowering action in detergent slurries

In a 500 ml heatable jacketed stainless steel vessel, three different detergent slurries were prepared with stirring. To this end, the liquid components were initially heated to 50° C. with stirring for 10 min. The stirrer used had a torque recorder. Within 4 min, the solid components mixed beforehand were metered in uniformly, in the course of which the slurry was stirred further at 150 rpm. On completion of addition, the slurry was stirred further at constant rotation rate to determine the torque.

The torque expresses the force which is required to stir the slurry at constant rotation speed. The lower the torque, the lower the viscosity of the detergent slurry.

Table 1 lists the compositions of the detergent slurries. The amounts mentioned relate to starting materials in anhydrous form, i.e. without water fractions or water of crystallization which are present in the overall water content.

Tables 2 to 4 compile the torques obtained in each case after 30 min. For comparison, the results obtained without added polymer and also with use of the copolymer of comparative example 1 are also listed. The result nd means that the viscosity of the slurry was very high and the torque could not be determined.

TABLE 1
Composition of the detergent slurries

| | Slurry 1 | Slurry 2 | Slurry 3 |
|---|---|---|---|
| Starting material | [% by wt.] | [% by wt.] | [% by wt.] |
| Dodecylbenzenesulfonate, | 13.9 | 17.2 | 8.1 |
| Na salt | | | |
| C₁₃/₁₅-oxo alcohol · 7 EO | 7.5 | 6.2 | 5.4 |
| Soap | — | — | 1.6 |
| Zeolite A | 21.4 | — | — |
| Sodium carbonate | 16.0 | 7.8 | 17.9 |
| Sodium hydrogencarbonate | — | — | 17.9 |
| Sodium metasilicate | 10.7 | — | 8.1 |
| Sodium disilicate | — | — | 3.6 |
| Sodium tripolyphosphate | — | 15.6 | — |
| Sodium citrate | — | — | 9.0 |
| Sodium sulfate | — | 27.3 | — |
| Copolymer | 1.1 | 1.8 | 0.9 |
| Total water content | 29.4 | 24.1 | 27.5 |
| Total solids content | 70.6 | 75.9 | 72.5 |

TABLE 2

| Copolymer from ex. | Torque [Ncm] after 30 min - slurry 1 |
|---|---|
| 1 | 12 |
| 2 | 10 |
| 3 | 10 |
| 4 | 15 |
| 5 | 15 |
| 6 | 10 |
| 7 | 15 |
| 8 | 16 |
| 9 | 19 |
| 10 | 15 |
| 11 | 14 |
| 12 | 24 |
| 13 | 17 |
| 14 | 20 |
| 15 | 15 |
| 16 | 12 |
| 17 | 15 |
| 18 | 12 |
| 19 | 15 |
| — | Nd |
| C1 | Nd |

TABLE 3

| Copolymer from ex. | Torque [Ncm] after 30 min - slurry 2 |
|---|---|
| 1 | 45 |
| 2 | 30 |
| 4 | 45 |
| 8 | 40 |
| 9 | 35 |
| 10 | 40 |
| 11 | 36 |
| 12 | 30 |
| 13 | 40 |
| — | Nd |
| C1 | Nd |

TABLE 4

| Copolymer from ex. | Torque [Ncm] after 30 min - slurry 3 |
|---|---|
| 4 | 20 |
| — | Nd |

The results obtained demonstrate the viscosity-lowering action of the inventive copolymers on detergent slurries, which at the same time also allows the preparation of more highly concentrated detergent slurries. For instance, in the case of the slurry 1 composition without the addition of an inventive copolymer, only a total solids content of 68% by weight (compared to 73.5% by weight when 1% by weight of the copolymer from example 4 is added) is attainable.

IIb) Testing of the Encrustation-Inhibiting Action in Detergents

To determine the encrustation-inhibiting action, the inorganic fabric deposits (encrustation) were determined in the form of the ash content.

To this end, a test fabric made of cotton washed with the detergent formulation described in table 5 under the wash conditions specified in table 6. After washing 15 times, the ash content of the test fabric was determined by ashing at 700° C. The results obtained are compiled in table 7. Without polymer addition, an ash content of 6.56% by weight was determined.

TABLE 5
Detergent composition

| Ingredients | [% by wt] |
|---|---|
| Linear alkylbenzenesulfonate (50%) | 6.0 |
| C₁₂ fatty alcohol sulfate · 2 EO | 2.0 |
| C₁₃C₁₅ oxo alcohol · 7 EO | 7.0 |
| Soap | 1.0 |
| Zeolite A | 36.0 |
| Sodium carbonate | 12.0 |
| Sodium metasilicate · 5 H₂O | 3.5 |
| Sodium perborate monohydrate | 15.0 |
| Tetraacetylethylenediamine | 3.5 |
| Sodium sulfate | 3.0 |
| Carboxymethylcellulose | 1.5 |
| Water | to 100 |

TABLE 6
Wash conditions

| | |
|---|---|
| Machine | Launder-o-meter from Atlas, Chicago, USA |
| Wash liquor | 250 ml |
| Wash duration | 30 min at 60° C. |
| Detergent dosage | 4.5 g/l |
| Water hardness | 4 mmol/l Ca:Mg:HCO₃ 4:1:8 |
| Liquor ratio | 1:12.5 |
| Wash cycles | 15 |
| Copolymer addition | 5% by weight |
| Test fabric | 10.0 g of cotton test fabric (BW 283, from |
| | Reichenbach) |

TABLE 7

| Copolymer from ex. | Ash content [% by wt.] |
|---|---|
| 2 | 5.41 |
| 7 | 4.70 |
| 8 | 4.06 |
| 15 | 3.91 |
| 16 | 3.72 |

1: A process for preparing granular or pulverulent detergent compositions, comprising the preparation of a detergent base powder by drying an aqueous detergent slurry, the process comprising adding to the slurry a copolymer that is obtained by the free-radical copolymerization of
(A) from 50 to 99.5 mol % of a monoethylenically unsaturated monocarboxylic acid and/or a salt thereof,
(B) from 0.5 to 20 mol % of an alkoxylated monoethylenically unsaturated monomer of the formula I 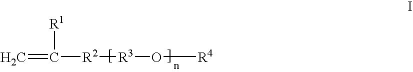
in which the variables are defined as follows:
R¹ is hydrogen or methyl;
R² is —(CH₂)ₓ—O—, —CH₂—NR⁵—, —CH₂—O—CH₂—CR⁶R⁷—CH₂—O— or —CONH—;
R³ are each identical or different C₂-C₄-alkylene radicals which may be arranged blockwise or randomly, the proportion of ethylene radicals being at least 50 mol %;
R⁴ is hydrogen, C₁-C₄-alkyl, —SO₃M or —PO₃M₂;
R⁵ is hydrogen or —CH₂—CR¹═CH₂;
R⁶ is —O—[R³—O]ₙ—R⁴ where the —[R³—O]ₙ— radicals may be different from the further —[R³—O]ₙ— radicals present in formula I;
R⁷ is hydrogen or ethyl;
M is alkali metal or hydrogen;
n is from 4 to 250; and
x is 0 or 1,
(C) from 0 to 50 mol % of a monoethylenically unsaturated dicarboxylic acid, of an anhydride and/or of a salt thereof and
(D) from 0 to 20 mol % of a further copolymerizable monoethylenically unsaturated monomer
and has an average molecular weight Mw of from 30 000 to 500 000 g/mol and a K value of from 40 to 150 (measured at pH 7 in 1% by weight aqueous solution at 25° C.).

2: The process according to claim 1, wherein the copolymer is one obtained by free-radical copolymerization of from 80 to 99.5 mol % of the monomers (A) and from 0.5 to 20 mol % of the monomers (B).

3: The process according to claim 1, wherein the copolymer is one obtained by free-radical copolymerization of from 60 to 98 mol % of the monomers (A), from 1 to 15 mol % of the monomers (B) and from 1 to 30 mol % of the monomers (C).

4: The process according to claim 1, wherein a copolymer based on acrylic acid is used as monomer (A).

5: The process according to claim 1, wherein a copolymer based on ethoxylated allyl ethers having from 10 to 100 mol of ethylene oxide/mol is used as monomer (B).

6: The process according to claim 1, wherein a copolymer based on maleic acid is used as monomer (C).

7: A process for reducing the viscosity of aqueous detergent slurries, comprising adding to the slurry a copolymer according to claim 1.

8: A detergent slurry comprising a copolymer according to claim 1.

9: A detergent composition comprising a copolymer according to claim 1.

10: A detergent composition comprising an additive that is a copolymer according to claim 1.
